(19) United States
(12) Patent Application Publication
(10) Pub. No.: US 2004/0103705 A1
(43) Pub. Date: Jun. 3, 2004

(54) Culture medium

(76) Inventor: Lucas Everhardus Maria Langezaal, Amersfoort (NL)

Correspondence Address: PEACOCK MYERS AND ADAMS P C, P O BOX 26927, ALBUQUERQUE, NM, 871256927

(21) Appl. No.: 10/655,629

(22) Filed: Aug. 28, 2003

Related U.S. Application Data
(63) Continuation of application No. PCT/NL02/00134, filed on Feb. 28, 2002.

(30) Foreign Application Priority Data
Feb. 28, 2001 (NL) NL 1017460

(51) Int. Cl. C05C 1/00; C05F 1/00

(52) U.S. Cl. 71/27

(57) ABSTRACT

A culture medium that is suitable for growing plants that comprises a filler and a polymer. The culture medium is characterized in that it is comprised of a polymerised mixture containing a biologically degradable polymer and the filler. To this polymerisable agent and the filler are mixed together and then polymerised. As biologically degradable polymers it is possible to use, for example, polylactic acid, starch and other substances. The culture medium preferably comprises a foamed polymer, which improves the ability to absorb water. The invention also relates to a method for the production of such a culture medium and to a container into which the culture medium can be put for growing plants.

### CROSS-REFERENCE TO RELATED APPLICATIONS

Not Applicable.

This application claims the benefit of the filing of International Patent Application Serial No. PCT/NL02/00134, filed on Feb. 28, 2002, which claimed priority of Dutch Patent Application Serial No. 1017460 filed Feb. 28, 2001, and the specifications thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to a culture medium that is suitable for growing plants, and which comprises a filler and a polymer. The invention also relates to a method for the production of such a culture medium. The invention also relates to a container for the culture medium according to the invention.

2. Description of Related Art

A culture medium as mentioned in the preamble is known in the art. U.S. Pat. No. 3,472,644, to Woodside, et al., describes a culture medium which comprises a polymer and a filler. Said document mentions that the polymer should have an excellent resistance to oxidation, bacteria and fungus. Then, according to U.S. Pat. No. 3,472,644, the polymer will remain intact during long periods of time. As an example of especially preferred suitable polymers, polyurethane is mentioned.

EP 0,209,709 to Bayer AG describes a culture medium wherein foamed polymer particles are used as a filler. Here also, said filler preferably is comprised of polyurethane.

JP 10-014408-A, to Tokai Kaei KK, describes a biodegradable culture medium, which consists of mixed starting materials.

The culture media as known from the above identified publications are to some extent solid, that is to say that they have a structure so as to allow a plant to grow roots therein. However, the media as known from the publications cited above hinder the roots from growing properly. Furthermore, the media known from U.S. Pat. No. 3,472,644 and EP 0,209,790 are not biologically degradable.

### BRIEF SUMMARY OF THE INVENTION

According to the invention the above-mentioned problems are solved by the fact that the culture medium as mentioned in the preamble is comprised of a foamed polymerized mixture of a biologically degradable polymerisable medium and the filler. In this way the filler, which serves as culture bed is contained in the polymer matrix, thereby providing a very coherent composition during the growing period. The foamed polymerized mixture provides an open structure in the polymer matrix, which provides a still improved environment for growing roots. After use the medium can be re-used as biological material.

So as to obtain said foamed polymer, a foaming agent is added to the mixture to provide an open structure in the polymer matrix. The foamed structure improves the absorption and retention of water in the mixture, which may be improved further by adding a wetting agent.

The object of the present invention is to alleviate the above mentioned problems. A particular object is to provide a culture medium that is completely biologically degradable and that does not impede the plant's growth.

Other objects, advantages and novel features, and further scope of applicability of the present invention will be set forth in part in the detailed description to follow, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

Not Applicable.

### DETAILED DESCRIPTION OF THE INVENTION

According to a preferred embodiment, the culture medium comprises 1 to 90% by volume of polymer, 2 to 98% by volume of filler, 1 to 80% by volume of foaming agent and optionally 0.001 to 20% by volume of setting agent. This provides a widely applicable range of suitable culture medium.

According to a further embodiment the culture medium according to the invention may be used in the form of a granulate. In that case the culture medium may be used as soil improvement agent. To this end it may optionally be mixed in with other substrates to obtain desirable characteristics and to be passed on to the soil.

For growing plants, the culture medium may be put into containers. Such containers comprise a plurality of hollows into which a quantity of medium may be put. For example, the medium may have a form and size so as to exactly fill a hollow. Such plugs may, for example, be cylindrical. Common diameters are 13 mm, 20 mm, 28 mm, 40 mm and 50 mm. the length is variable.

It is also possible to embody the culture medium as a mat, allowing several plants to grow in the culture medium.

By mixing the biologically degradable polymers, the foaming agents (e.g., thermic leavening agents), the fillers and optionally the thickening agents and the surfactant (wetting agents) in specific mixing ratios in an extruder, the influence of temperature and a limited amount of water, will yield a mixture, which when leaving the extruder will provide a foamed substrate. Depending on the mixing ratios of the components, the foam effect obtained in the substrate will be more or less, and depending on the outflow diameter of the extruder and the pressure in the extruder, either a thick or thin substrate strand will be produced. The amounts required for a particular final product may be determined by trial.

The biologically degradable polymer may be any known polymer not producing harmful substances during decomposition. A choice may be made from, for example:

1) biologically degradable polyesters such as statistic, aliphatic-aromatic copolyesters that are based on the different monomers of butanediol, adipic acid and terephthalic acid;

2) polylactic acid compounds, among which the A and the D variant;

3) polyhydroxybutyrate (PHB) compounds and polyhydroxyalkanoate (PHA) compounds; and

4) the starch compounds.

For example, and preferably, a biologically degradable polymer of synthetic origin or a biologically degradable polymer of renewable origin (of the group 2, 3 or 4 above, for example biopolymer) may be used. The above mentioned polymers, separately or combined with each other, may give the foam result mentioned. By means of varying the combinations it is possible to regular for example the degradation time, the ability to absorb water and the hardness of the substrate.

The filler may be chosen from substances known in the art such as for example peat, compost, clay, soil, coconut fibers, coconut granulate, hemp fibers, grass fibers, straw, sawdust, coffee dregs, residue from the cattle feed industry or from the paper industry.

The method for the production of the culture medium comprises mixing together a polymerisable agent, in a foaming agent and a filler, wherein according to the invention the polymerisable agent is chosen from substances that after polymerization produce a biologically degradable polymer and in that after mixing, the polymerisable agent is foamed and polymerized. In this way a culture medium is obtained in which the filler is distributed through the polymer mould. Said foaming agent is added to endow the culture medium with improved characteristics, as mentioned above.

The foaming process may be enhanced by the addition of a leavening agent, for example, a thermic leavening agent such as bicarbonate.

The type of polymer and the amount as well as the mixing ratio of the bio polymers and synthetic polymers as well as the type and the amount of filler, determine together with the type and the amount of foaming agent not only the degree of foaming but also other specific characteristics, such as the absorption of water and the rate of biological degradation. Thus this rate of degradation can be regulated and can be adapted for each desired culture application.

The rate of the substrate's absorption of water may be influenced by the addition of a surfactant such as a generally known wetting agent. Larger quantities of this agent will increase the rate of the substrate's water absorption.

The container for the culture medium as mentioned above is produced, in accordance with the invention, from a biologically degradable polymer. This may be produced in the same manner as the culture medium. The substrate is directly injected (warm or cold) from the extruder into a mold after which the mold is pressed. It preferably also comprises a foaming agent and an organic filler. According to a particular preferred embodiment, the container is produced by using a preferably biologically degradable, water-repellent agent (hydrophobic agent, such as organo-modified siloxanes) in the mixture. For example, the biologically degradable polymer may be an at least partly water repellent polymer. In this way the container will not absorb water. Ingrowth of roots will to a certain extent be prevented. According to a further preferred embodiment the container has a closed structure, for example, surface structure, such that it is not possible for the roots to grow into it.

Under the influence of temperature, moisture and organisms in the soil, the polymer is degraded into the products CO₂ and H₂O, and biomass. The degradation products must not contain any components that are harmful to plants.

The filler may be any substance known in the art in the form of granules, fibers or powder that is organic and not harmful to the environment. In particular said substance may not contain any components that are harmful to the plants to be grown.

In general, the method for producing the culture medium is carried out in an extruder. The various substances may be mixed with the filler and polymerized. Optionally, a foaming agent and a water-resistant agent may be added. The quantities and the ratios of the various starting materials are determined by the characteristics the container is desired to have. In general, the container should have a structure such as to prevent the ingrowth of roots. It is partly water repellent. In this way the container will retain a sufficiently firm consistency during use. If a foaming agent is added, it will generally be in a relatively limited amount in order to restrict the porosity. The container preferably has a closed surface structure.

If a container is to be used once only, the container may be cut up after the plants have been raised, and used as general soil improvement agent. If the container had a closed surface structure, cutting up will expose the open structure so as to allow biological degradation to take place more quickly.

As foaming agent the known biologically acceptable foaming agents may be used, such as water and sodium bicarbonate. Other foaming agents or methods, such as direct gas injection are of course also possible.

The quantities may be varied, depending on the characteristics the culture medium to be produced is desired to have. If little foaming activity is desired, only a small amount of foaming agent is used. If rapid biodegradability is desired, the amount of polymer may be reduced or another type of polymer or another mixture may be used, while of course the culture medium must retain an adequate consistence. The amount of filler may also be adjusted as desired.

The culture medium according to the invention is extremely suitable for use as growth medium or as medium for cuttings, suitable for putting in seeds or cuttings.

It is also very suitable as a growth medium wherein young plants are transplanted into a large-volume substrate, to be raised to mature plants.

The culture medium is also very suitable for use as production medium, wherein it is present in the form of a substrate mat, the plants being used as production plant for the harvest of fruit or flowers.

It is also suitable as soil improvement agent, wherein the culture medium according to the invention, preferably in the form of granulates or granules optionally is mixed with other substances to afford better growth conditions.

In the solid form, for example cylindrical, cubic, rectangular, oblong, the culture medium may be used in corresponding hollows in suitable containers provided for the purpose.

As already mentioned, the containers according to the invention may be conveniently used for growing plants and germinating seeds. The containers may also be used for inserting and holding flowers or other parts of plants in bouquets, flower arrangements, Christmas bouquets, and the like.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A culture medium suitable for growing plants, comprising a filler and a polymer, wherein the culture medium is comprised of a foamed polymerised mixture of a biologically degradable polymer and the filler.

2. A culture medium according to claim 1, wherein the culture medium comprises 1 to 90% by volume of polymer, 2 to 98% by volume of filler, 1 to 80% by volume of foaming agent.

3. A culture medium according to claim 1, wherein the culture medium comprises a plant or seed to be cultured.

4. A culture medium according to claim 1, wherein the culture medium is a granulate.

5. A culture medium according to claim 1, wherein the culture medium additionally comprises 50 to 95% by volume of water.

6. A culture medium according to claim 1, wherein the biologically degradable polymer is chosen from at least one of:
a) biologically degradable polyesters;
b) polylactic acid compounds;
c) polyhydroxybutyrate (PHB) compounds and polyhydroxyalkaoate (PHA) compounds; and
d) starch compounds.

7. A culture medium according to claim 1, wherein the filler is an organic material.

8. A method for the production of a culture medium according to claim 1, comprising mixing together a polymerisable agent, a foaming agent and a filler, wherein the polymerisable agent is chosen from substances that after polymerisation produce a biologically degradable polymer and after mixing the polymerisable agent is foamed and polymerised.

9. A method according to claim 8, wherein a foaming agent in an amount of 15 to 60% by volume is mixed together with the polymerisable agent in an amount of 2 to 25% by volume, and the filler in an amount of 30 to 75% by volume.

10. A container for a culture medium according to claim 1, wherein the same is produced from a biologically degradable polymer.

11. A container according to claim 10, wherein the container comprises a biologically degradable foaming agent and a polymerisable agent in an amount of 1 to 90% by volume.

12. A container according to claim 10, wherein the container comprises a biologically degradable water repellent agent.

13. A container according to claim 10, wherein the container has a structure to prevent roots from growing into it.

14. A culture medium according to claim 2, wherein the culture medium comprises 0.001 to 20% by volume of surfactant.

15. A culture medium according to claim 2, wherein the culture medium comprises 2 to 25% by volume of polymer, 30 to 75% by volume of filler, and 15 to 50% by volume of foaming agent.

16. A culture medium according to claim 15, wherein the culture medium comprises 0.001 to 10% by volume of surfactant.

17. A culture medium according to claim 5, wherein the culture medium comprises 55 to 85% by volume of water.

18. A culture medium according to claim 17, wherein the culture medium comprises 65 to 80% by volume of water.

19. A culture medium according to claim 6, wherein the biologically degradable polyesters are selected from the group consisting of statistic, aliphatic-aromatic copolyesters that are based on the different monomers of butanediol, adipic acid and teraphthalic acid.

20. A culture medium according to claim 7, wherein the organic material is selected from the group consisting of peat, compost, clay, soil, coconut fibers, coconut granulate, hemp fibers, grass fibers, straw, sawdust, coffee dregs, residue from the cattle feet industry or from the paper industry.

21. A container according to claim 11, wherein the container comprises an organic filler.
